(19) United States
(12) Patent Application Publication
(10) Pub. No.: US 2022/0032986 A1
(43) Pub. Date: Feb. 3, 2022

(54) SAFE SHOPPING UNIVERSAL PUSH BAR

(71) Applicants: Andreas Tikovsky, Tenino, WA (US); Dominic Tikovsky, Tenino, WA (US)

(72) Inventors: Andreas Tikovsky, Tenino, WA (US); Dominic Tikovsky, Tenino, WA (US)

(21) Appl. No.: 16/943,986

(22) Filed: Jul. 30, 2020

(51) Int. Cl. B62B 5/06

(52) U.S. Cl. CPC B62B 5/065; B62B 5/068

(57) ABSTRACT

An article of manufacture for a universal push bar to create a hygienically safe shopping cart according to the present invention is disclosed. The universal push bar is made of a main push bar having a first end and a second end, a pair of support members having an upper end coupled to the main push, a first support member coupled about the first end of the main push bar and a second support member coupled about the second end of the main push bar, and a pair of claiming mechanisms coupled to each lower end of the pair of support members, the pair of claiming mechanisms having a pair of opposing claiming surfaces configured to attach the clamping mechanisms to a shopping cart handle.

### TECHNICAL FIELD

This application relates in general to an article of manufacture for providing a personal protection device, and more specifically, to an article of manufacture for a universal push bar that creates a hygienically safe shopping cart.

### BACKGROUND

Customers utilize an ordinary shopping cart to collect multiple items at a store. The use of a shopping cart is most prevalent when shopping for groceries. Each customer using a shopping cart is likely to also touch fruits, vegetables, packaged meats, cheeses, and other items all of which may carry microbes and pathogens from the handling and care of the items at their source and to the grocery. Additionally, customers themselves may be a source for microbes, pathogens, and viruses of many types from the common flu virus to pandemic-causing pathogens. A customer uses a push bar that is part of the shopping cart to navigate about the store while handling items. Anything that comes in contact with a customer's hands may easily be transferred to the shopping cart push bar and remain on the push bar when a subsequent customer uses the same shopping cart. While some establishments may provide anti-microbial wipes for customers to use to wipe the push bar before use, the availability of such wipes is not guaranteed, and use may not be possible in all situations.

Therefore, a need exists for a device that permits a customer to navigate a store using a shopping cart without having to come into direct contact with the shopping cart push bar. Any device needs to be easily portable for a customer to bring to the store, needs to easily attach and detach to the shopping cart, and needs to provide complete control over the movement of the shopping cart when attached. The present invention attempts to address the limitations found in prior art systems using the principles and features disclosed herein.

### SUMMARY

In accordance with the present invention, the above and other problems are solved by providing to an article of manufacture for a universal push bar to create a hygienically safe shopping cart according to the principles and example embodiments disclosed herein.

In one embodiment, the present invention is an article of manufacture for a universal push bar to create a hygienically safe shopping cart. The universal push bar is made of a main push bar having a first end and a second end, a pair of support members having an upper end coupled to the main push, a first support member coupled about the first end of the main push bar and a second support member coupled about the second end of the main push bar, and a pair of claiming mechanisms coupled to each lower end of the pair of support members, the pair of claiming mechanisms having a pair of opposing claiming surfaces configured to attach the clamping mechanisms to a shopping cart handle.

In another aspect of the present invention, each of the clamping mechanisms comprises a C-shaped clamp having a first clamping surface and an opposing clamping surface, a moving clamping surface for engaging the shopping cart handle between the moving clamping surface and the first clamping surface, and a threaded rod having a first end and a second end, the first end of the threaded rod is coupled to one side of the moving clamping surface and the second end of the coupled to a tightening knob, the threaded rod engaging a threaded thru hole in the opposing claiming surface. Rotation of the tightening knob positions the moving clamping surface closer to the first claiming surface and further from the first clamping surface the threaded rod rotates within the threaded thru hole depending upon the direction of rotation of the tightening knob.

The foregoing has outlined rather broadly the features and technical advantages of the present invention in order that the detailed description of the invention that follows may be better understood. Additional features and advantages of the invention will be described hereinafter that form the subject of the claims of the invention.

It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only, and is not intended as a definition of the limits of the present invention.

### BRIEF DESCRIPTION OF THE DRAWINGS

Referring now to the drawings in which like reference numbers represent corresponding parts throughout:

FIGS. 1a-b illustrate an example embodiment of an article of manufacture for a universal push bar to create a hygienically safe shopping cart according to the present invention.

FIGS. 2a-c illustrate other example embodiments of an article of manufacture for a universal push bar to create a hygienically safe shopping cart according to the present invention.

FIG. 3 illustrates an example embodiment of an article of manufacture for a universal push bar to create a hygienically safe shopping cart according to the present invention.

FIG. 4 illustrate yet another example embodiment for an article of manufacture for a universal push bar to create a hygienically safe shopping cart according to the present invention.

### DETAILED DESCRIPTION

This application relates in general to an article of manufacture for providing a personal protection device, and more specifically, to an article of manufacture for a universal push bar to create a hygienically safe shopping cart according to the present invention.

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In describing embodiments of the present invention, the following terminology will be used. The singular forms “a,” “an,” and “the” include plural referents unless the context clearly dictates otherwise. Thus, for example, reference to “a needle” includes reference to one or more of such needles and “etching” includes one or more of such steps. As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. As used herein, the singular forms “a,” “an,” and “the” are intended to include the plural forms as well, unless the context clearly indicates otherwise.

It further will be understood that the terms “comprises,” “comprising,” “includes,” and “including” specify the presence of stated features, steps or components, but do not preclude the presence or addition of one or more other features, steps or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

As used herein, the term “about” means that dimensions, sizes, formulations, parameters, shapes, and other quantities and characteristics are not and need not be exact, but may be approximated and/or larger or smaller, as desired, reflecting tolerances, conversion factors, rounding off, measurement error and the like, and other factors known to those of skill. Further, unless otherwise stated, the term “about” shall expressly include “exactly.”

The terms “customer,” and “user” refer to an entity, e.g. a human, using the safe shopping universal push bar attached to a shopping cart associated with the invention. The term user herein refers to one or more users.

The term “invention” or “present invention” refers to the invention being applied for via the patent application with the title “Safe Shopping Universal Push Bar.” Invention may be used interchangeably with push bar.

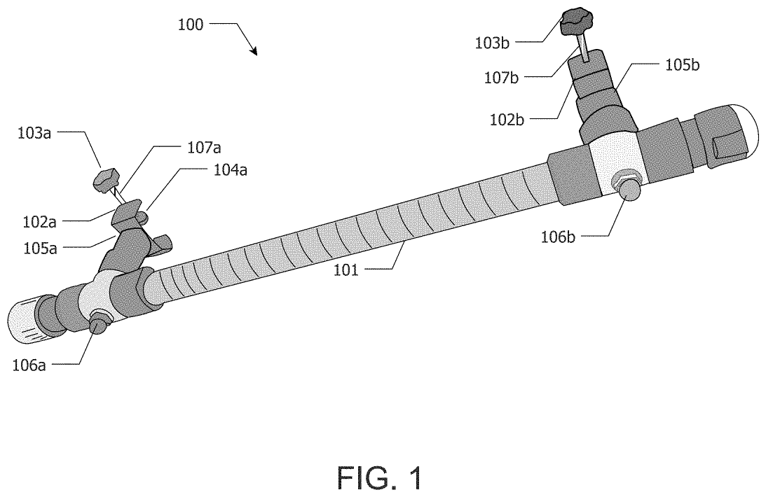

In general, the present disclosure relates to an article of manufacture for providing a personal protection device. To better understand the present invention, FIGS. 1a-b illustrate an example embodiment for to an article of manufacture for a universal push bar to create a hygienically safe shopping cart according to the present invention. The safe shopping universal push bar 100 comprises a main push bar 101 coupled to a pair of support members 105a-b in which each support member 105a-b has a clamping mechanism 102a-b on a lower end of the support member 105a-b from the main push bar 101.

The pair of claiming mechanisms 102a-b permit the push bar 100 to be attached to a shopping cart without the user having to come into contact with the shopping cart. The main push bar 101 is arranged parallel to the shopping cart push bar while being separated by the length of the support members 105a-b. The main push bar 101 may be coupled to the pair of support members 105a-b in different ways. In the embodiment of FIG. 1, the support members 105a-b are coupled to the main push bar 101 mechanically using a pair of through bolts capped by a pair of attachment nuts 106a-b. The support members 105a-b also may be mechanically coupled using a clamping collar that tightens about the main push bar. Additionally, the support members 105a-b also may be welded to the main push bar 101 to create a single device.

The main push bar 101 is shown in FIG. 1 to be a solid rod coupled between the two support members 105a-b. The main push bar 101 may also be constructed using a telescoping shaft that permits the length of the main push bar 101 to be reduced in size when carried or stored by a customer. In such an embodiment, the various segments of the telescoping push bar may include locking mechanisms, such as twist locks and lever-operated locks to hold the main push bar 101 in place while in use.

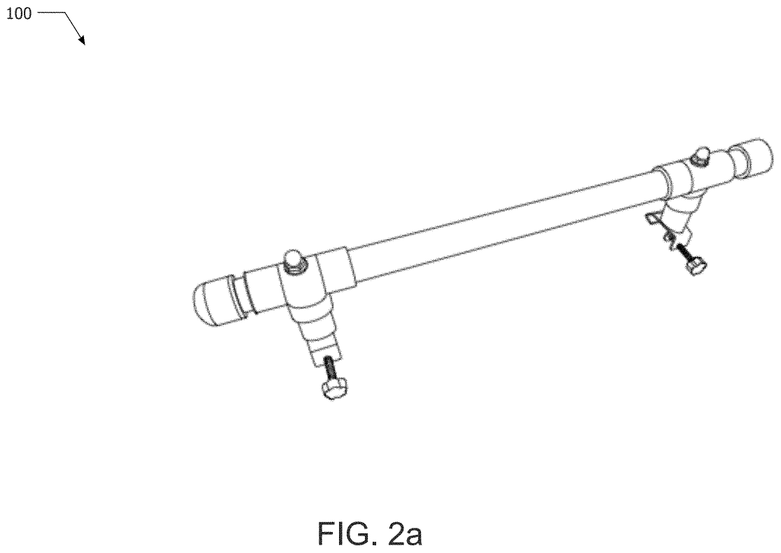

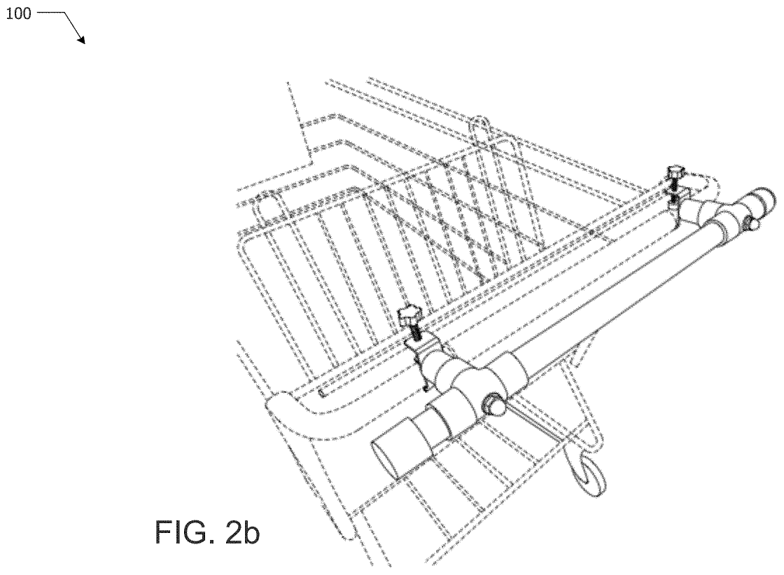

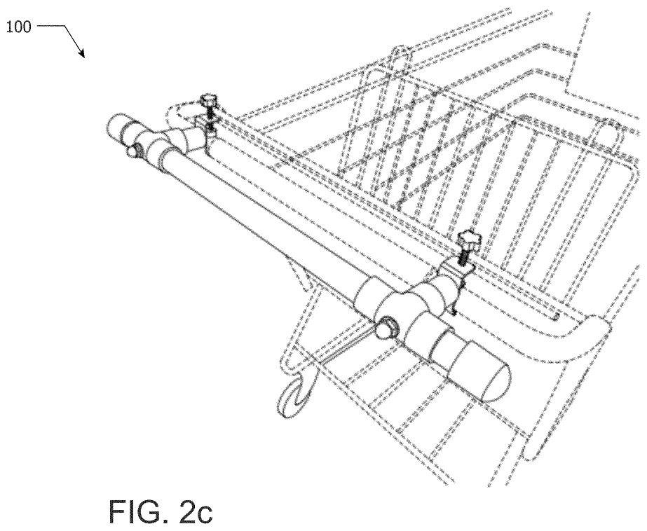

The pair of attachment members 105a-b is used to securely couple the push bar 100 to the shopping cart push bar. Examples of a push bar attached to a shopping cart are illustrated in FIGS. 2a-c and 4a-c. In the embodiment of FIG. 1, the pair of attachment members 105a-b comprise a C-shaped clamping mechanisms 102a-b having a pair of opposing clamping surfaces, a moving clamping surface 104a-b attached to a threaded rod 107a that engages a threaded hole through the opposing clamping surface of the C-shaped clamping surfaces of the attachment mechanisms 102a-b. A tightening knob 103a-b is located on an opposite end of the threaded rod 107a from the clamping surface 106a. When a user rotates the tightening knobs 103a-b, the threaded rod 107a rotates moving the clamping surface 106a either inward or outward.

If the push bar of the shopping cart is placed between the moving clamping surface and the opposing C-shaped surface of the attachment member 102a-b, the tightening knob 103a-b permits the attachment members 102a-b to be easily clamped onto the shopping cart push bar. Once shopping has been completed, rotation of the tightening knobs 103a-b in the opposite direction loosens the attachment members 102a-b from the shopping cart push bar in order for the user to remove the push bar 100 once done shopping. All of the interaction between the attachment members 102a-b and the shopping cart may occur with the user only coming into contact with the push bar 100 and the tightening knobs 103a-b.

FIGS. 2a-c illustrate other example embodiments of an article of manufacture for a universal push bar to create a hygienically safe shopping cart according to the present invention. The main push bar 101 may be made of a metal material such as steel or aluminum and may be covered with a layer of vinyl or rubber material 101. As such, the user may utilize the push bar 100 by handling the vinyl rubber, or cloth tape material covering the main push bar 101 between the pair of support members 105a-b. The push bar 100 as shown in FIGS. 2a-c is attached to a shopping cart 201 in the manner disclosed above in reference to FIG. 1.

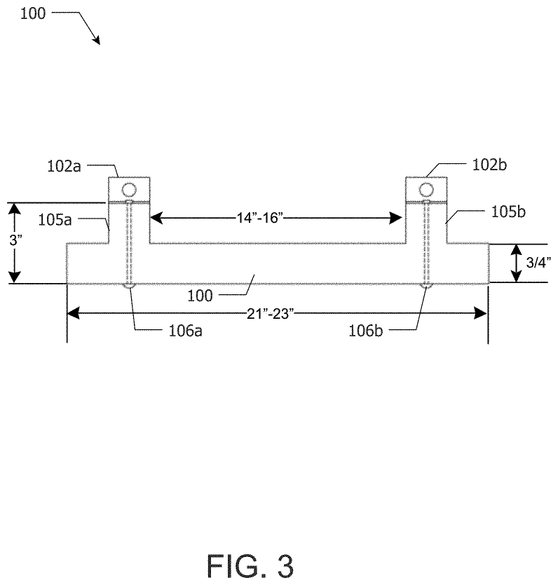

FIG. 3 illustrates an example embodiment of an article of manufacture for a universal push bar to create a hygienically safe shopping cart according to the present invention. The example embodiment of the push bar 100 shows dimensions for a preferred embodiment. The main push bar 101 is typically between 21″-23″ in length and a ¾″ pipe. The support members 102a-b are 2 ¼″ in length to position the main push bar 101 3″ about the shopping cart push bar. The pair of support members 102a-b are between 14″-16″ apart and secured to the main push bar 101 using a ¼″ screw. The threaded member 107a connects the tightening knob 103a-b to the clamping surface 106a-b using a 1¼″ threaded screw.

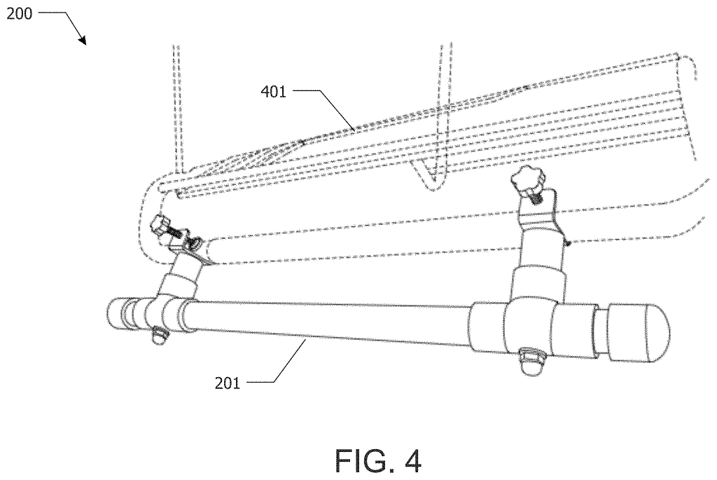

FIG. 4 illustrate yet another example embodiment for an article of manufacture for a universal push bar to create a hygienically safe shopping cart according to the present invention. In this embodiment, the safe shopping universal push bar 200 is shown with the main push bar 201 being made of copper. The main push bar 101 may be made of: solid copper, copper plating or a layer of copper covering the outside surface of the main push bar 201. As such, the user may utilize the push bar 200 by handling the copper surfaces to obtain the anti-microbial benefits naturally provided from the use of copper. The push bar 200 as shown in FIG. 2. 4 is attached to a shopping cart in the manner disclosed above in reference to FIGS. 1 and 2a-c.

Even though particular combinations of features are recited in the present application, these combinations are not intended to limit the disclosure of the invention. In fact, many of these features may be combined in ways not specifically recited in this application. In other words, any of the features mentioned in this application may be included to this new invention in any combination or combinations to allow the functionality required for the desired operations.

No element, act, or instruction used in the present application should be construed as critical or essential to the invention unless explicitly described as such. Further, the phrase “based on” is intended to mean “based, at least in part, on” unless explicitly stated otherwise.

What is claimed:

1. An article of manufacture for providing a personal protection device, and more specifically, to an article of manufacture for a universal push bar that creates a hygienically safe shopping cart, the article comprises:
a main push bar having a first end and a second end;
a pair of support members having an upper end coupled to the main push, a first support member coupled about the first end of the main push bar and a second support member coupled about the second end of the main push bar; and
a pair of claiming mechanisms coupled to each lower end of the pair of support members, the pair of claiming mechanisms having a pair of opposing claiming surfaces configured to attach the clamping mechanisms to a shopping cart handle.

2. The article of manufacture according to claim 1, wherein each of the clamping mechanisms comprises:
a C-shaped clamp having a first clamping surface and an opposing clamping surface,
a moving clamping surface for engaging the shopping cart handle between the moving clamping surface and the first clamping surface;
a threaded rod having a first end and a second end, the first end of the threaded rod is coupled to one side of the moving clamping surface and the second end of the coupled to a tightening knob, the threaded rod engaging a threaded thru hole in the opposing claiming surface;
wherein rotation of the tightening knob positions the moving clamping surface closer to the first claiming surface and further from the first clamping surface the threaded rod rotates within the threaded thru hole depending upon the direction of rotation of the tightening knob.

3. The article of manufacture according to claim 2, wherein each of the pair of support members are coupled to the main push bar using a using a pair of through bolts capped by a pair of attachment nuts.

4. The article of manufacture according to claim 3, wherein the main push bar is covered by a handle material comprising vinyl, rubber, and cloth covering tape between the pair of support members.

5. The article of manufacture according to claim 2, wherein main push bar is made of a solid metal rod.

6. The article of manufacture according to claim 5, wherein the solid metal rod is made of steel.

7. The article of manufacture according to claim 5, wherein main push bar comprises a collapsible telescoping member permitting the length of the main push bar to be reduced in length when not in use.

8. The article of manufacture according to claim 5, wherein the metal rod is made of copper.

9. The article of manufacture according to claim 8, wherein the main push bar, and the pair of support members, the first clamping surface and the opposing clamping surface are coupled together into a single metal object made entirely of copper.

10. The article of manufacture according to claim 2, wherein the main push rod has a diameter of ¾″ and the pair of support members are coupled to the main push bar a distance between 21″ and 23″.
